(19) United States
(12) Patent Application Publication
(10) Pub. No.: US 2020/0057736 A1
(43) Pub. Date: Feb. 20, 2020

(54) INFORMATION SHARING CIRCUIT AND METHOD FOR SHARING MEMORY STATE

(71) Applicants: INVENTEC (PUDONG) TECHNOLOGY CORPORATION, Shanghai City (CN); INVENTEC CORPORATION, Taipei City (TW)

(72) Inventor: Xu-Xiang WU, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/135,750

(22) Filed: Sep. 19, 2018

(30) Foreign Application Priority Data
Aug. 15, 2018 (CN) 201810930593.X

(51) Int. Cl. G06F 13/16; G06F 11/22; G06F 11/30; G06F 13/40; G06F 13/42

(52) U.S. Cl. CPC G06F 13/1694; G06F 13/1689; G06F 11/2284; G06F 2213/0016; G06F 13/4068; G06F 13/4282; G06F 11/3058

(57) ABSTRACT

An information sharing circuit for sharing the information of a memory module comprises an input port, two storage units, a control unit, and two output ports. The control unit instructs the input port to receive an information collection from the memory module and store the information collection to the first and the second storage unit. Two output ports are respectively electrically connected to two distinct external devices. The information collection is sent to the corresponding external device when any of the two output ports receives a request from the connected external devices respectively.

### CROSS-REFERENCE TO RELATED APPLICATIONS

This non-provisional application claims priority under 35 U.S.C. § 119(a) on Patent Application No(s). 201810930593.X filed in China. on Aug. 15th, 2018, the entire contents of which are hereby incorporated by reference.

### TECHNICAL FIELD

The disclosure relates to an information sharing of memory, more particularly to state information sharing of a memory supporting SPD.

### BACKGROUND

SPD (Serial Presence Detect) is a standardized way to automatically access information about a memory configuration. The memory module supporting SPD often uses an EEPROM (Electrically Erasable Programmable Read Only Memory) to provide the memory configuration parameters of the memory module, such as the chip type of the memory, the manufacturer, the operating frequency, the operating voltage, the speed, the capacity and the bit widths of column and row. In general, these configurations are typically written to the EEPROM chip by the manufacturer according to the real performance of the memory chip at the factory.

After the computer is powered on, the BIOS of the motherboard reads the SPD information recorded in the EEPROM. The chipset automatically configures the corresponding operating timing sequence and control registers of memory according to the read SPD information, so it can avoid failures caused by setting errors when the memory parameters are manually adjusted, and the performance of the memory can be fully utilized. In practice, the temperature sensor and the EEPROM on the memory module are often integrated into the same chip. Therefore, the present temperature of the memory module can be obtained during the reading of the SPD information.

During the POST (Power-On Self Test) stage, the CPU reads the SPD information through the SMBus (System Management Bus), and the BMC (Baseboard Management Controller) reads the temperature sensing value of the temperature sensor in the other time. For SMBus, the CPU and the BMC are master devices, while the temperature sensors and EEPROM integrated chips are slave devices. The slave devices can only be accessed by one master at a time. As a result, the SMBus linking the memory module not only needs to be used to link the CPU, but also needs to be used to link the BMC, and a switch is used for switching the transmission path. After the end of the POST stage, the CPU sends a signal to the switch for switching. At the same time, the CPU further sends another signal to notify the BMC which is authorized to access the SMBus and is able to read the temperature of the memory module.

### SUMMARY

According to one or more embodiment, an information sharing circuit adapted for electrically linking a memory module and a plurality of external devices, comprising: an input port for obtaining an information collection from the memory module, wherein the information collection comprises a plurality of state parameters; a first storage unit electrically connecting to the input port and storing the information collection; a second storage unit electrically connecting to the input port and storing the information collection; a control unit electrically connecting to the input port, wherein the control unit is adapted for instructing the input port to obtain the information collection and storing the information collection into the first storage unit and the second storage unit respectively; a first output port electrically connecting to the first storage unit, with the first output port adapted for electrically connecting to a first external device and for sending the information collection from the first storage unit to the first external device when receiving a request from the first external device; and a second output port electrically connecting to the second storage unit, with the second output port adapted for electrically connecting to a second external device and for sending the information collection from the second storage unit to the second external device when receiving a request from the second external device.

According to one or more embodiment, the input port, the first output port and the second output port of the information sharing circuit adopt SMB or I²C. The control unit of the information sharing circuit further comprises a timer for accumulating a time interval, and the control unit instructs the input port to obtain the information collection from the memory module when the time interval reaches a first period. The first external device or the second external device sends the request periodically with a second period and the second period is shorter than the first period.

According to one or more embodiment, a method for sharing memory state comprising: obtaining an information collection by an input port instructed by a control unit, wherein the information collection relates to a state of a memory module; storing the information collection by a first storage unit and a second storage unit, wherein the first storage unit electrically connects to a first output port and the second storage unit electrically connects to a second output port; sending the information collection to a first external device by the first output port when the first output port receiving a request from the first external device; and sending the information collection to a second external device by the second output port when the second output port receiving another request from the second external device

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of the information sharing circuit and application environment thereof according to an embodiment of the present disclosure;

FIG. 2 is a flowchart of the method for sharing memory state according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

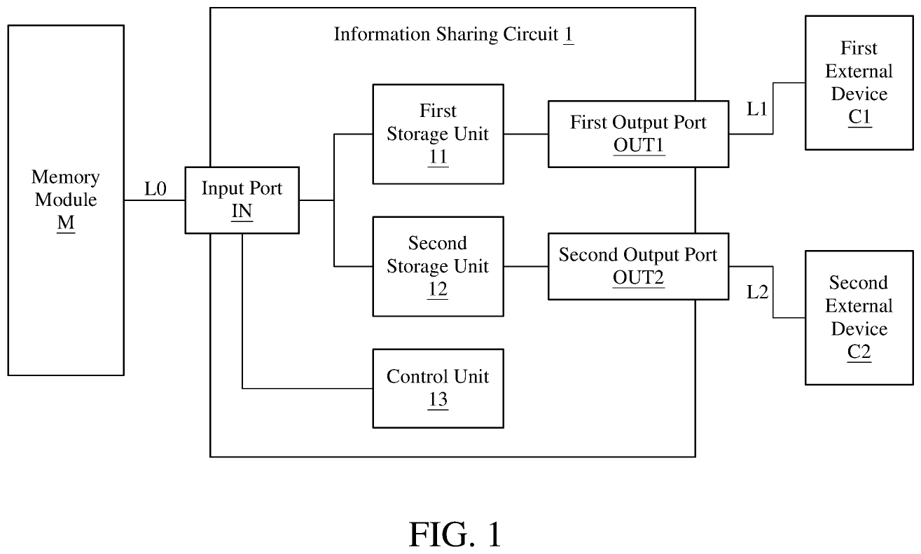

Please refer to FIG. 1, which illustrates the block diagram of the information sharing circuit and the application environment thereof according to an embodiment of the present disclosure. The information sharing circuit 1 is adapted for electrically linking the memory module M and the plurality of external device C1 and C2, wherein the memory module M supports SPD (Serial Presence Detect). The memory module M may provide a plurality of state parameters, and one of these state parameters is a temperature detecting value of the memory module M itself. In practice, the external devices C1 and C2, are such as a CPU (Central Processing Unit) and a BMC (Baseboard Management Controller).

The information sharing circuit 1 comprises the input port IN, the first storage unit 11, the second storage unit 12, the control unit 13, the first output port OUT1 and the second output port OUT2.

Please refer to FIG. 1. The input port IN is for obtaining an information collection from the memory module M. The information collection comprises a plurality of state parameters associated with the memory module M. In practice, the input port IN adopts SMB (System Management Bus) or I²C (Inter-Integrated Circuit) bus to electrically connect to the memory module M.

Please refer to FIG. 1. The first storage unit 11 electrically connects to the input port IN and stores the information collection obtained from the input port IN. Similarly, the second storage unit 12 electrically connects to the input port IN and stores identical information collection. In practice, the first storage unit 11 and the second storage unit 12 may be the volatile memory.

Please refer to FIG. 1. The control unit 13 electrically connects to the input port IN. The control unit 13 is adapted for instructing the input port IN to obtain the information collection from the memory module M, and instructing the first storage unit 11 and the second storage unit 12 to store the information collection respectively. In an embodiment of the present disclosure, the control unit 13 further comprises a timer for accumulating a time interval. When the time interval reaches the first period, the control unit 13 instructs the input port IN to obtain the information collection from the memory module M. In other words, the control unit 13 obtains the latest state parameters from the memory module M at intervals, and a first period is defined as the interval.

Please refer to FIG. 1. The first output port OUT1 electrically connects to the first storage unit 11 and the first external device C1. The first output port OUT1 sends the information collection from the first storage unit 11 to the first external device C1 when receiving a request from the first external device C1. Likewise, the second output port OUT2 electrically connects to the second storage unit 12 and the second external device C2. The second output port OUT2 sends the information collection from the second storage unit 12 to the second external device C2 when receiving a request from the second external device C. Both the first output port OUT1 and the second output port OUT2 adopt SMB or I²C bus to electrically connect to the first external device C1 and the second external device C2.

The information sharing circuit 1 may be a CPLD (Complex Programmable Logic Device) or an FPGA (Field Programmable Gate Array). In addition, the number of the storage unit and the input port are not limited to two sets as these in the present disclosure. In practice, the same number of storage units and the output port can be set according to the number of external devices.

The BMC has to monitor temperatures of every memory module M on the server at any time. Therefore, the BMC, as one of the first external device Cl or the second external device C2, sends the request periodically with the second period to the information sharing circuit 1 according to an embodiment of the present disclosure, thereby obtaining the latest temperature sensing value. As described above, the control unit 13 obtains the latest state parameters from the memory module M, and these state parameters comprise the temperature sensing value sensed by the temperature sensor on the memory module M. In practice, the first period should be set smaller than the second period, so that the BMC can obtain the most instantaneous temperature sensing value every time sending a request.

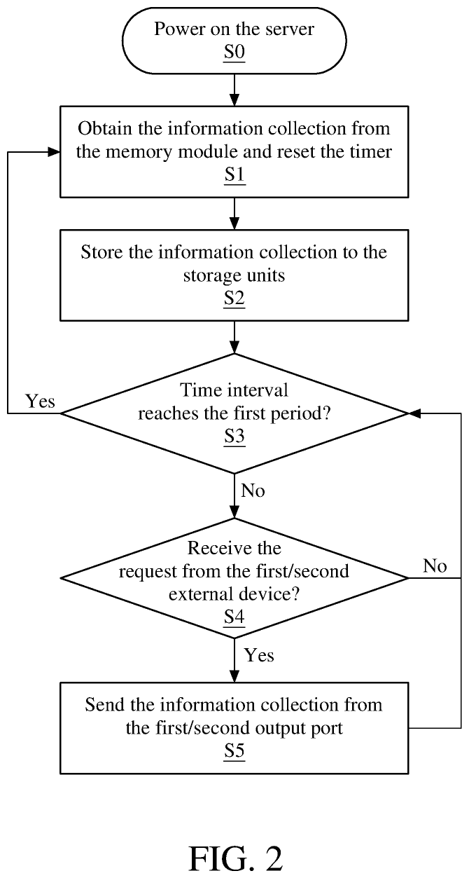

Please refer to FIG. 2, which illustrates a flowchart of the method for sharing memory state according to an embodiment of the present disclosure.

Please refer to step S0, “Power on the server”. With this step, the information sharing circuit 1, the memory module M, and the external device C1 and C2 according to an embodiment of the present disclosure are powered on and start to operate.

Please refer to step S1, “Obtain the information collection form the memory module M and reset the timer”. Specifically, after the server is powered on, the control unit 13 inside the information sharing circuit 1 instructs the input port IN to obtain the temperature sensing value and the SPD information stored in the integrated chip of the temperature sensor and the EEPROM through the system management bus. At the same time, the control unit 13 also resets the timer to start accumulating the time interval after obtaining the information collection in this time, and updates the information collection every first period afterward.

Please refer to step S2, “Store the information collection to the storage units”. Specifically, the control unit 13 instructs the first storage unit 11 and the second storage unit 12 to store the information collection obtained from the output port.

Please refer to step S3, “Determine whether the time interval reaches the first period?” If the accumulated time has reached the first period, the method for sharing memory state according to an embodiment of the present disclosure returns to step S1, the control unit 13 instructs the input port IN to obtain the information collection and resets the timer to re-accumulate the time interval. Otherwise, if the accumulated time has not reached the first period, the method for sharing memory state, step S4 is performed.

Please refer to step S4, “Determine whether the output port receive the request from the first/second external device C1/C2”. For example, during the POST (Power-On Self-Test) stage, the CPU as the first external device C1 issues a request to obtain the SPD information of the memory module M, or the BMC as the second external device C2 issues a request according to the monitoring requirement to obtain the latest temperature sensing value from the memory module M. In step S4, if the first output port OUT1 receives the request from the first external device C1 or the second output port OUT2 receives the request from the second external device C2, step S5 is performed. Otherwise, the method for sharing memory state according to an embodiment of the present disclosure returns to step S3.

Please refer to step S5, “Send the information collection from the first/second output port OUT1/OUT2”. Specifically, after confirming receipt of the request from the external device C1/C2, the output port OUT1/OUT2 send the information collection stored in the storage unit 11/12 to the corresponding external device C1/C2 according to the requested item. After performing step S5, the method for sharing memory state according to an embodiment of the present disclosure returns to step S3 and determines again whether the information collection in the storage unit 11 and 12 needs to be updated.

Because the storage unit 11, 12 and the output port OUT1, OUT2 of the information sharing circuit 1 according to the embodiment of the present disclosure and the external device C1, C2 have a one-to-one correspondence, the obtaining of state parameters of the memory module M by the CPU and the BMC can be performed independently without affecting each other.

In sum, the information sharing circuit and the method for sharing memory state according to an embodiment of the present disclosure obtain all of the state parameters (comprising the temperature sensing value), which are associated with the memory module and are from integrated chip of the temperature sensor and the EEPROM, through the information sharing circuit implemented by CPLD after the server and the memory are powered on. The information collection is stored in the registers virtualized by the CPID. The first external device (such as the CPU) and the second external device (such as the BMC) can separately send the request to access the storage units of the information sharing circuit, thereby obtaining the temperature sensing value and the SPD information. During the process described above for accessing the state parameters of the memory module, the operations of the first external device and the second external device are performed independently without any affection to each other. In addition, since the BMC has a default frequency for monitoring the temperature, the information sharing circuit of the present disclosure can use a higher frequency to obtain the temperature sensing value from the temperature sensor and update the internal storage units. Therefore, BMC can obtain the most instantaneous and latest temperature sensing value by using the information sharing circuit of the present disclosure.

What is claimed is:

1. An information sharing circuit adapted for electrically linking a memory module and a plurality of external devices, comprising:
an input port for obtaining an information collection from the memory module, wherein the information collection comprises a plurality of state parameters;
a first storage unit electrically connecting to the input port and storing the information collection;
a second storage unit electrically connecting to the input port and storing the information collection;
a control unit electrically connecting to the input port, wherein the control unit is adapted for instructing the input port to obtain the information collection and storing the information collection into the first storage unit and the second storage unit respectively;
a first output port electrically connecting to the first storage unit, with the first output port adapted for electrically connecting to a first external device and for sending the information collection from the first storage unit to the first external device when receiving a request from the first external device; and
a second output port electrically connecting to the second storage unit, with the second output port adapted for electrically connecting to a second external device and for sending the information collection from the second storage unit to the second external device when receiving a request from the second external device.

2. The information sharing circuit according to claim 1, wherein the information sharing circuit is a CPLD or an FPGA.

3. The information sharing circuit according to claim 1, wherein the input port, the first output port and the second output port adopt SMB or I²C.

4. The information sharing circuit according to claim 1, wherein the control unit further comprises a timer for accumulating a time interval, and the control unit instructs the input port to obtain the information collection from the memory module when the time interval reaches a first period.

5. The information sharing circuit according to claim 4, wherein the first external device or the second external device sends the request periodically with a second period and the second period is shorter than the first period.

6. The information sharing circuit according to claim 1, wherein the memory module supports SPD.

7. The information sharing circuit according to claim 1, wherein one of the state parameters is a temperature parameter of the memory module.

8. The information sharing circuit according to claim 1, wherein the first external device or the second external device is a CPU or a BMC.

9. The information sharing circuit according to claim 1, wherein the first storage unit or the second storage unit is a volatile memory.

10. A method for sharing memory state comprising:
obtaining an information collection by an input port instructed by a control unit, wherein the information collection relates to a state of a memory module;
storing the information collection by a first storage unit and a second storage unit, wherein the first storage unit electrically connects to a first output port and the second storage unit electrically connects to a second output port;
sending the information collection to a first external device by the first output port when the first output port receiving a request from the first external device; and
sending the information collection to a second external device by the second output port when the second output port receiving another request from the second external device.
